(19) United States
(12) Patent Application Publication
(10) Pub. No.: US 2008/0276514 A1
(43) Pub. Date: Nov. 13, 2008

(54) SOUVENIR BADGE

(75) Inventor: Lien-Hsin Lee, Luchou City (TW)

Correspondence Address: MOLDETK PRECISION CORP., P.O. BOX 108-00403, TAIPEI 106, TW

(73) Assignee: MOLDETK PRECISION CORP., Wugu Township (TW)

(21) Appl. No.: 11/746,068

(22) Filed: May 9, 2007

(51) Int. Cl. G09F 3/18

(52) U.S. Cl. 40/661.04

(57) ABSTRACT

A souvenir badge includes a badge body that shows a design and has pointed stem for piercing a nonmetal sheet member, for example, a visor of a sports cap, and a positioning block that has a center insertion hole for receiving the pointed stem to secure the badge body positively to the nonmetal sheet member through which the pointed step pierced. The badge body and the positioning block can be fastened together by means of magnetic attraction.

### BACKGROUND OF THE INVENTION

1. Field of the Invention

The present invention relates to badges and more particularly, to a souvenir badge, which comprises a badge body with a particular shape to show a design, and a pointed stem perpendicularly extending from the bottom side of the badge body for securing the badge body to a nonmetal sheet member, for example, a visor of a sports cap.

2. Description of the Related Art

A badge is a device presented or displayed to indicate some feat of service, a special accomplishment, a symbol of authority, a sign of legitmate employment or student status, or to tell other something interesting about you. They are also used in advertising and publicity. Like coins and stamps, badges have become highly collectible: Monument badge is one of the popular badges functions. When a new monument is established, the landscape owner or management authority may issue a badge for memory. For example, when Hong Kong Disneyland is opened, it becomes a hot landsacpe in Asia. While visiting this landscape, visitors usually will buy a souvenir badge from the shops in Disneyland.

Further, when a local, national, or international festival, cultral activity or sports activity is held, the organization in charge may also issue souvenir badges for collection. Since Athens Olympic, it has become a convention of the Olympic games to issue souvenir badges. Generally an Olympic souvenir badge is a circular copper plate carrying the Olympic logo, the symbol of the holding city, and other marks concerned.

Further, modern people have critical requirements for badges. In addition to any practical use, beauty, innovation and unique feature are the main factors to attract people to buy a badge. To compete in market, it is necessary to provide a creative design.

### SUMMARY OF THE INVENTION

The present invention has been accomplished under the circumstances in view.

According to one aspect of the present invention, the souvenir badge comprises a badge body and a positioning block. The badge body has a head and at least one pointed stem perpendicularly extending from the bottom side of the head for fastening the badge body to a nonmetal sheet member. The head can be made in any of a variety of shapes to show a symbol or design. The positioning block has at least one center insertion hole for receiving the pointed stem, not limited to one, respectively.

According to another aspect of the present invention, the badge body and the positioning block are made out of a magnetic material so that the positioning block attracts the at least one pointed stem of the badge body by magnetic force.

### BRIEF DESCRIPTION OF THE DRAWINGS

FIG. 1 is an exploded view of a souvenir badge in accordance with the present invention.

FIG. 2 illustrates an application example of the souvenir badge shown in FIG. 1.

FIG. 3 illustrates another application example of the souvenir badge shown in FIG. 1.

FIG. 4 illustrates still another application example of the souvenir badge shown in FIG. 1.

FIG. 5 illustrates still another application example of the souvenir badge shown in FIG. 1.

FIG. 6 is an exploded view of an alternative form of the souvenir badge according to the present invention.

FIG. 7 is an exploded view of another souvenir form of the souvenir badge according to the present invention.

### DETAILED DESCRIPTION OF THE PREFERRED EMBODIMENT

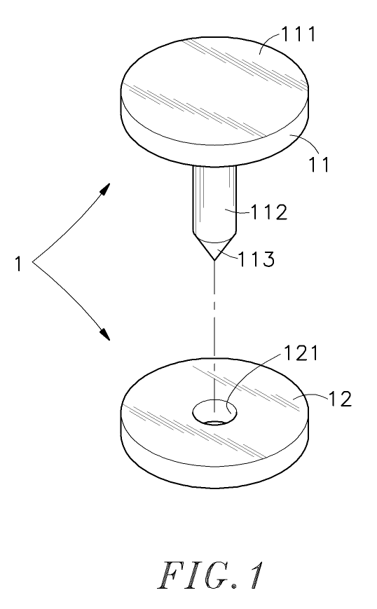

Referring to FIG. 1, a souvenir badge 1 in accordance with the present invention is shown comprising a badge body 11. The badge body 11 has a head 111, and a stem 112 perpendicularly extended from the bottom side of the head 111 at the center. The stem 112 according to this embodiment is a round rod having a pointed tip 113. The head 111 can be made in a circular, rectangular, or any of a variety of shapes, or the shape of a character or important person to show a design. According to this embodiment, the head 111 has a flat circular shape. Further, the number of the stem 112 according to this embodiment is 1. In actual practice, the number of the stem 112 may be increased subject to the size of the head 111.

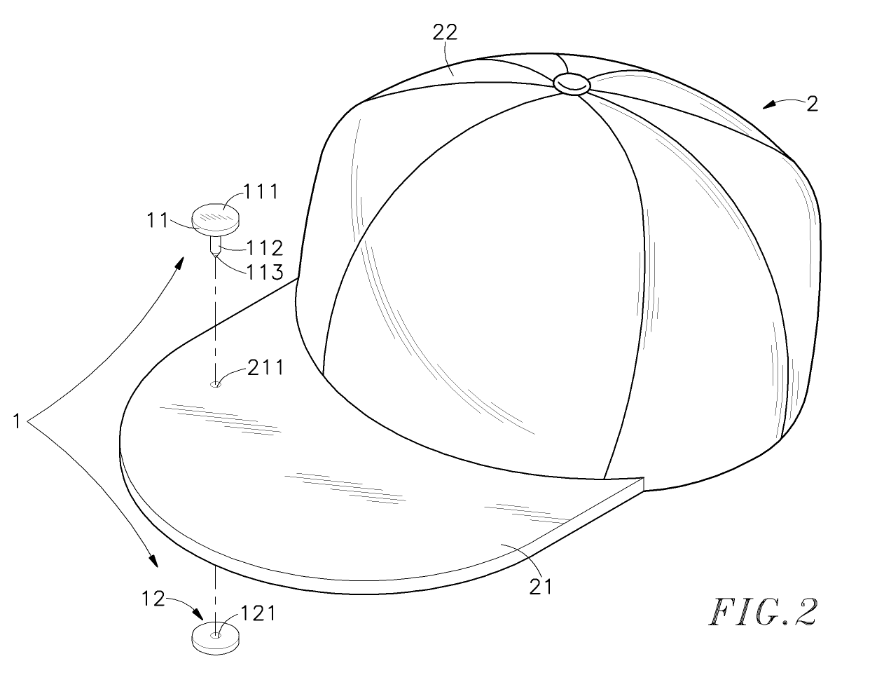

Referring to FIG. 2, by means of the pointed tip 113, the stem 112 can be inserted through a through hole 211 on a visor 21 of a sports cap 2 to secure the souvenir badge 1 to the sports cap 2. The sports cap 2 has a crown 22 to cover the head. The visor 21 extends outward from the bottom edge of the crown 22. After inserting the stem 112 through the visor 21 of the sports cap 2, a positioning block 12 is fastened to the stem 112 and stopped at the bottom side of the visor 21 to secure the stem 112 to the visor 21 positively. The positioning block 12 has a center insertion hole 121 for receiving the stem 112 in a tight manner.

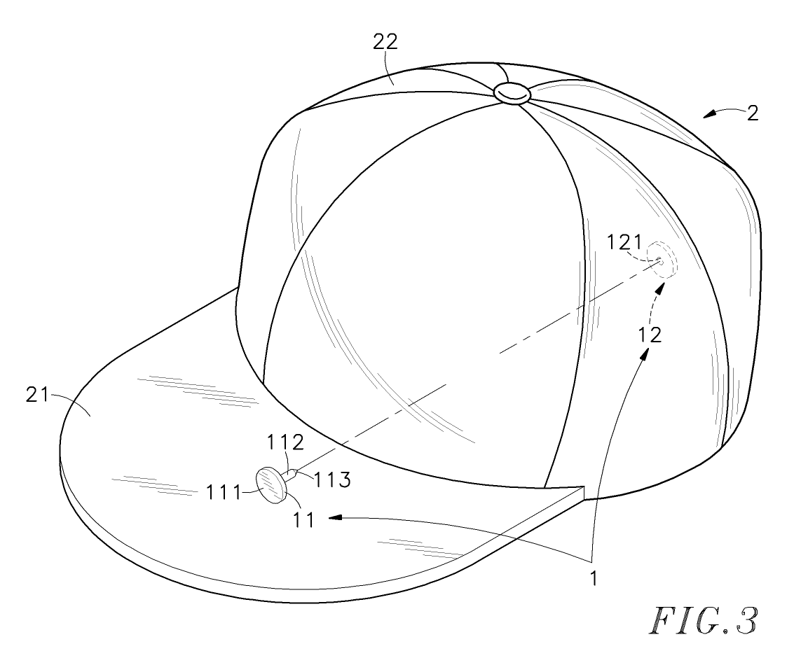

Referring to FIG. 3, the souvenir badge 1 can be fastened to the crown 22 of the sports cap 2 by forcing the stem 112 through the crown 22 and then fitting the stem 112 into the center insertion hole 121 of the positioning block 12.

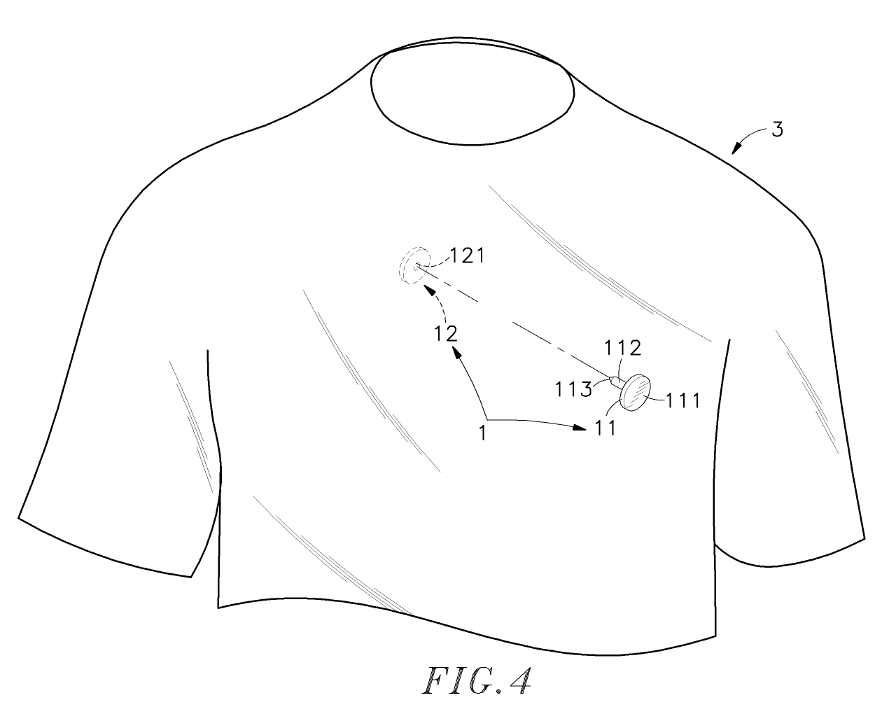

Referring to FIG. 4, the souvenir badge 1 can be fastened to a user's clothe 3 by forcing the stem 112 through the user's clothe 3 and then fitting the pointed tip 113 of the stem 112 into the center insertion hole 121 of the positioning block 12.

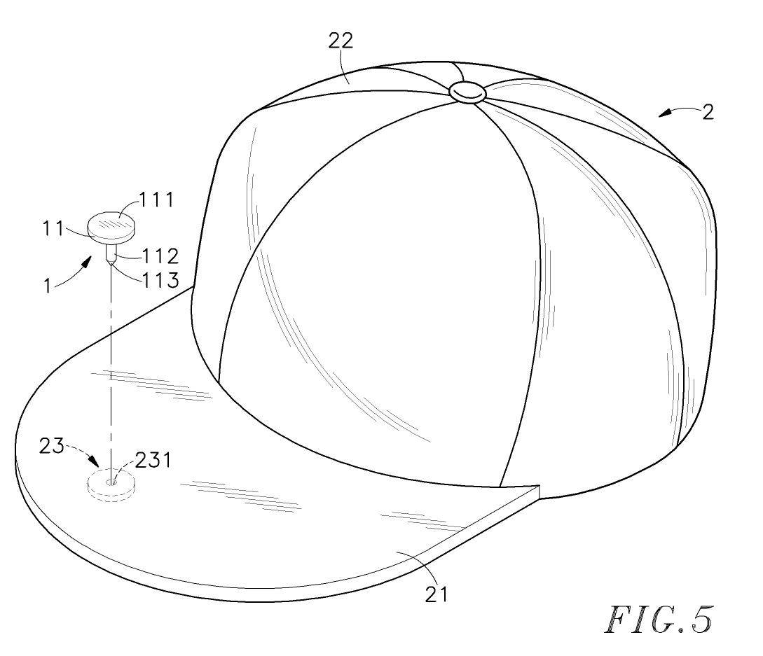

Referring to FIG. 5, a positioning block 23 is embedded in the visor 21 of the sports cap 2, having a center insertion hole 231 for receiving the stem 112 of the badge body 11.

Further, the badge body 11 and positioning block 12 or 23 can be made out of a magnetic material so that the badge body 11 and the positioning block 12 or 23 can be firmly secured together by means of magnetic force.

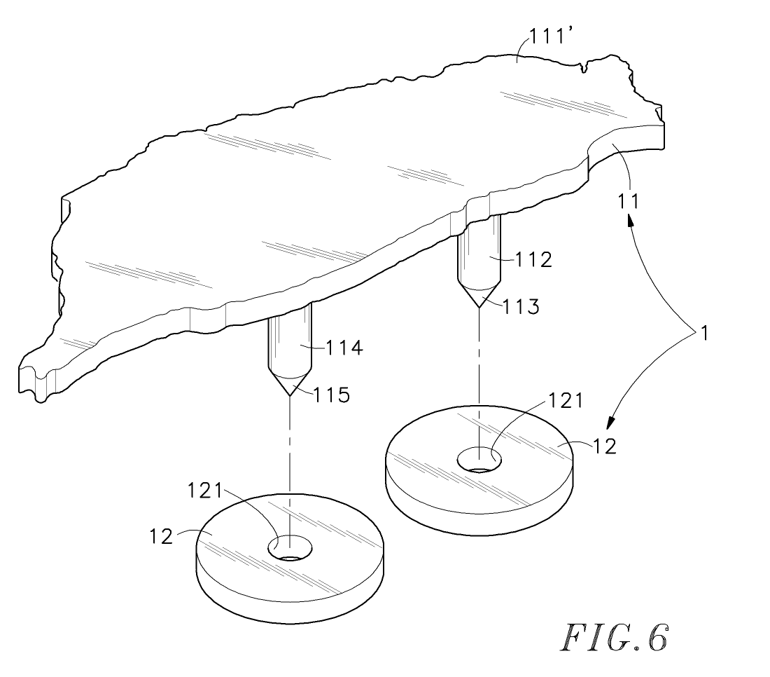

FIG. 6 is an exploded view of an alternative form of the present invention. According to this embodiment, the souvenir badge 1 is comprised of a badge body 11 and two positioning blocks 12. The badge body 11 has a head 114, and two stems 112 and 115 perpendicularly extending from the bottom side of the head 114. The head 114 shows a pattern, for example, the shape of Taiwan. The two stems 112 and 115 are arranged in parallel for insertion through the cloth or fabric of a device, each having a pointed tip 113. The positioning blocks 12 each have a center insertion hole 121 for receiving the stems 112 and 115 to secure the badge body 11 to the cloth or fabric body of the device.

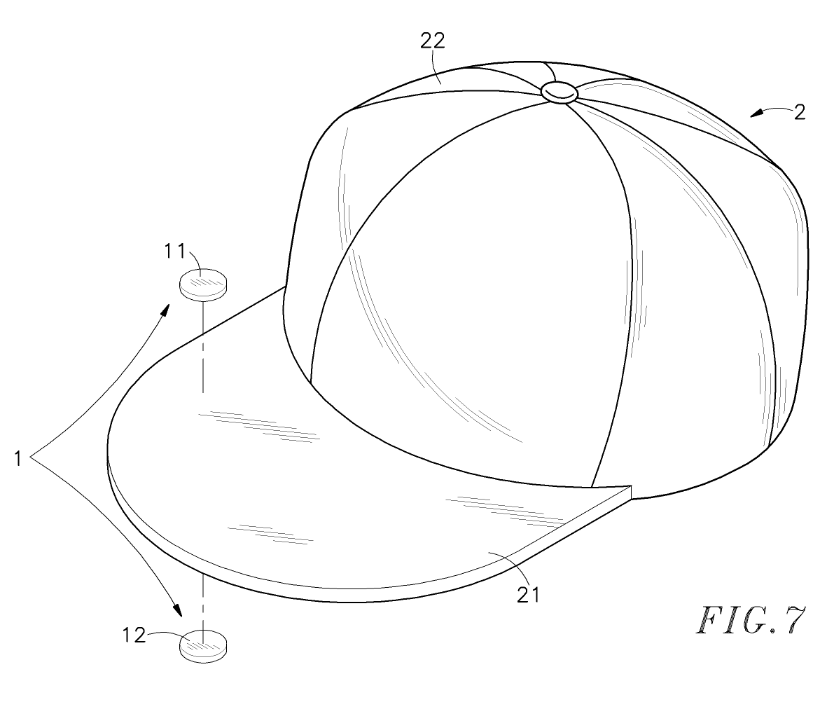

FIG. 7 illustrates another alternative form of the present invention. According to this embodiment, the souvenir badge 1 is comprised of a badge body 11 and a positioning block 12. The badge body 11 and the positioning block 12 are respectively made out of a magnetic material in a flat circular shape. When attach the badge body 11 and the positioning block 12 to a fabric or sheet member at two opposite sides, they attract each other and are secured firmly to the fabric or sheet member.

In general, the invention provides a souvenir badge that has the following advantages:

1. By means of the stem 111, the badge body 11 can be firmly fastened to a device (for example, the visor 21 of a sports cap 2). The use of the positioning block 12 enhances the installation stability of the badge body 11. The souvenir badge 1 when installed in a device (for example, the visor 21 of a sports cap 2), it decorates the device, and shows a commercial value in addition to the artistic value.

2. By means of the magnetic attraction property of the souvenir badge 1, a small metal device, for example, a golf counter can be secured to the badge body 11 after installation of the souvenir badge 1 in a golf equipment or accessory.

Although particular embodiments of the invention have been described in detail for purposes of illustration, various modifications and enhancements may be made without departing from the spirit and scope of the invention. Accordingly, the invention is not to be limited except as by the appended claims

What the invention claimed is:

1. A souvenir badge comprising a badge body, which has a head and at least one stem perpendicularly extending from a bottom side of the head for fastening the badge body to a sheet member. There is one stem each having a pointed tip for piercing through the sheet member.

2. The souvenir badge as claimed in claim 1, with at least one stem is respectively inserted through a visor of a sports cap to secure the badge body to the sports cap.

3. The souvenir badge as claimed in claim 2, further comprising at least one positioning block attached to a bottom side of the visor of the sports cap opposite to the head of the badge body to secure the badge body to the visor with at least one positioning block each having a center insertion hole for receiving the stem(s) respectively.

4. The souvenir badge as claimed in claim 2, further comprising at least one positioning block embedded in the visor of the sports cap to secure the badge body to the visor, with at least one positioning block each having a center insertion hole for receiving the stem(s) respectively.

5. The souvenir badge as claimed in claim 1 with two stems minimum, and the two stems are arranged and spaced from each other at a predetermined distance.

6. A souvenir badge comprising a flat badge body that shows a design, and a flat positioning block for securing the flat badge body to a nonmetal sheet member, the flat badge body and the flat positioning block being secured together by means of magnetic attraction when attached to two opposite sides of the nonmetal sheet member.

7. The souvenir badge as claimed in claim 6, wherein the flat positioning block is embedded in a visor of a sports cap for securing the flat badge body by means of magnetic force.
